(19) United States
(12) Patent Application Publication
(10) Pub. No.: US 2009/0054133 A1
(43) Pub. Date: Feb. 26, 2009

(54) GAMING APPARATUS EXECUTING RACE BY A PLURALITY OF RACE OBJECTS, AND GAME CONTROL METHOD THEREOF

(75) Inventor: Hiroki SAITO, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Aruze Corp., Koto-ku (JP)

(21) Appl. No.: 12/186,910

(22) Filed: Aug. 6, 2008

(30) Foreign Application Priority Data
Aug. 22, 2007 (JP) 2007-216231

(51) Int. Cl. A63F 13/00

(52) U.S. Cl. 463/25

(57) ABSTRACT

A gaming apparatus of the present invention comprises: an image display; a bet input device with which a bet on a race object that participates in a racing game in which a plurality of race objects contend with one another for winning can be inputted; and a controller, the controller programmed so as to execute the processing of (F) determining whether or not to offer a special award, and (G) displaying an enlarged view of at least a portion of an effect image to the image display, when it is determined in the processing (F) to offer the special award.

### CROSS-REFERENCE TO RELATED APPLICATIONS

This application claims benefit of priority based on Japanese Patent Application No. 2007-216231 filed on Aug. 22, 2007. The contents of this application are incorporated herein by reference in their entirety.

### BACKGROUND OF THE INVENTION

### Field of the Invention

The present invention relates to a gaming apparatus that executes a race by a plurality of race objects, and a game control method thereof.

Conventionally, gaming apparatuses such as horse racing game apparatuses have been known that execute a racing game in which a plurality of race objects contend with one another for winning (cf. U.S. Pat. No. 6,210,275, U.S. Pat. No. 6,358,150, U.S. Pat. No. 6,450,887, U.S. Pat. No. 6,634,944, JP-A 2001-87461, U.S. Pat. No. 6,848,991, JP-B 3291287, U.S. Pat. No. 6,905,410, JP-B 3366308, U.S. Pat. No. 6,921,331, U.S. Pat. No. 6,929,550, JP-A 2002-85852, U.S. Pat. No. 6,962,529, JP-A 2002-035429, U.S. Pat. No. 7,025,353, and U.S. Pat. No. 7,172,508). A player who plays a game on such a gaming apparatus predicts which race object will win in the racing game, based on information provided from the gaming apparatus and his or her hunch, and bets game media such as medals on the race object. Then, when the prediction proves correct, the player can receive an award in accordance with the betted game media.

The contents of U.S. Pat. No. 6,210,275, U.S. Pat. No. 6,358,150, U.S. Pat. No. 6,450,887, U.S. Pat. No. 6,634,944, JP-A 2001-87461, U.S. Pat. No. 6,848,991, JP-B 3291287, U.S. Pat. No. 6,905,410, JP-B 3366308, U.S. Pat. No. 6,921,331, U.S. Pat. No. 6,929,550, JP-A 2002-85852, U.S. Pat. No. 6,962,529, JP-A 2002-035429, U.S. Pat. No. 7,025,353, and U.S. Pat. No. 7,172,508 are incorporated herein by reference in their entirety.

However, in the conventional horse racing game apparatuses, a player monotonously repeats a series of operations of predicting which race object will win, placing a bet based on the prediction, and watching a racing game to recognize whether or not the prediction proves correct; thus, there has been a problem in that the player gets bored of a game in a short period of time.

Further, even when a racing game is watched on such a horse racing game apparatus, there has been a problem of lacking liveliness as compared with a real horse racing where real racehorses run in front of spectators' eyes.

The present invention was made in view of the foregoing problems, and has an object to provide a gaming apparatus with such consideration as to prevent a player from getting bored and also to enhance liveliness, and a game control method of the gaming apparatus.

### SUMMARY OF THE INVENTION

In order to solve the foregoing problems, the present invention provides the following.

(1) A gaming apparatus, comprising:

an image display capable of displaying an image;

a bet input device with which a bet on a race object that participates in a racing game in which a plurality of race objects contend with one another for winning can be inputted; and

a controller,

the controller programmed so as to execute the processing of

(A) accepting a bet from the bet input device,

(B) proceeding with the racing game,

(C) displaying an effect image in accordance with the progress of the racing game,

(D) determining the order of finish of the plurality of race objects that participate in the racing game,

(E) offering a normal award, based on the bet accepted in the processing (A) and on the order of finish of the race object which has been determined in the processing (D),

(F) determining whether or not to offer a special award different from the normal award offered in the processing (E), and

(G) displaying to the image display an enlarged view of at least a portion of the effect image, when it is determined in the processing (F) to offer the special award.

According to the invention of (1), a normal award is offered based on a bet accepted from the bet input device and on the orders of finish of race objects. Further, it is determined whether or not to offer the special award different from the normal award, and when it is determined to offer the special award, an enlarged image of at least a portion of the effect image is displayed to the image display.

Therefore, according to the invention of (1), since a game does not monotonously proceed but a varied game proceeds due to the special effect of displaying the enlarged image, it is possible to prevent the player from getting bored and also to enhance liveliness.

Further, the present invention provides the following.

(2) The gaming apparatus according to the above-mentioned

(1),

wherein

the processing (G) includes the processing of

(G-1) displaying to the image display a photo-finish image formed by enlarging a portion of a goal image showing the state of at least a race object first crossing the finish line, the portion including at least the race object finishing first, after displaying the goal image to the image display in the processing (C).

According to the invention of (2), when it is determined to offer the special award, a photo-finish image formed by enlarging a portion of the goal image, the portion at least including the race object finishing first, is displayed to the image display after a goal image showing the state of at least a race object first crossing the finish line has been displayed to the image display. Therefore, it is possible to make the player focus his or her attention on the photo-finish image to see which race object has finished first.

Further, the present invention provides the following.

(3) The gaming apparatus according to the above-mentioned

(2),

wherein

when it is determined in the processing (F) to offer the special award, the controller executes in the processing (G) the processing of

(G-2) displaying the photo-finish image to the image display after displaying the goal image to the image display in the processing (C), and

(G-3) displaying an image showing the order of finish of the race objects which has been determined in the processing (D) to the image display after displaying the photo-finish image to the image display, and

when it is determined in the processing (F) not to offer the special award, the controller executes in the processing (G) the processing of

(G-4) displaying an image showing the order of finish of the race objects which has been determined in the processing (D) to the image display after displaying the goal image to the image display in the processing (C).

According to the invention of (3), when it is determined not to offer the special award, an image showing the order of finish of the race objects is displayed to the image display after the goal image has been displayed to the image display. On the other hand, when it is determined to offer the special award, the photo-finish image is displayed to the image display after the goal image has been displayed to the image display; and thereafter, the image showing the order of finish of the race objects is displayed to the image display. Therefore, when it is determined to offer the special award, the image showing the order of finish of the race objects is not displayed immediately after the goal image has been displayed, but the photo-finish image is first displayed after the goal image has been displayed, and thereafter the image showing the order of finish of the race objects is displayed. It is therefore possible to make the player have an expectation as to which race object finished first.

Further, the present invention provides the following.

(4) The gaming apparatus according to the above-mentioned

(1),

wherein

the processing (G) includes the processing of

(G-5) displaying to the image display an image showing that the special award will be offered.

According to the invention of (4), when it is determined to offer the special award, an image showing that the special award will be offered is displayed to the image display, which allows clear indication of offering of the special award. It is therefore possible to make the player easily recognize that the special award will be offered.

Further, the present invention provides the following.

(5) A game control method, including the steps of:

(A) accepting a bet from a bet input device with which a bet on a race object that participates in a racing game in which a plurality of race objects contend with one another can be inputted;

(B) proceeding with the racing game;

(C) displaying an effect image in accordance with the progress of the racing game;

(D) determining the order of finish of the plurality of race objects that participate in the racing game;

(E) offering a normal award, based on the bet accepted in the step (A) and on the order of finish of the race object which has been determined in the step (D);

(F) determining whether or not to offer a special award different from the normal award offered in the step (E); and

(G) displaying an enlarged view of at least a portion of the effect image to an image display capable of displaying an image, when it is determined in the step (F) to offer the special award.

According to the invention of (5), a normal award is offered based on a bet accepted from a bet input device and on the orders of finish of race objects. Further, it is determined whether or not to offer a special award different from the normal award, and when it is determined to offer the special award, an image formed by enlarging at least a portion of an effect image is displayed to an image display.

Therefore, according to the invention of (5), since a game does not monotonously proceed but a varied game proceeds due to the special effect of displaying the enlarged image, it is possible to prevent the player from getting bored and also to enhance liveliness.

Further, the present invention provides the following.

(6) The game control method according to the above-mentioned (5),

wherein

the step (G) includes the step of

(G-1) displaying to the image display a photo-finish image formed by enlarging a portion of a goal image showing the state of at least a race object first crossing the finish line, the portion including at least the race object finishing first, after displaying the goal image to the image display in the processing (C).

According to the invention of (6), when it is determined to offer the special award, a photo-finish image formed by enlarging a portion of the goal image, the portion at least including the race object finishing first, is displayed to the image display after a goal image showing the state of at least a race object first crossing the finish line has been displayed to the image display. Therefore, it is possible to make the player focus his or her attention on the photo-finish image to see which race object has finished first.

Further, the present invention provides the following.

(7) The game control method according to the above-mentioned (6),

wherein

when it is determined in the step (F) to offer the special award, the step (G) includes the steps of:

(G-2) displaying the photo-finish image to the image display after displaying the goal image to the image display in the step (C); and

(G-3) displaying an image showing the order of finish of the race objects which has been determined in the step (D) to the image display after displaying the photo-finish image to the image display, and

when it is determined in the step (F) not to offer the special award, the step (G) includes the step of

(G-4) displaying an image showing the order of finish of the race objects which has been determined in the step (D) to the image display after displaying the goal image to the image display in the step (C).

According to the invention of (7), when it is determined not to offer the special award, an image showing the order of finish of the race objects is displayed to the image display after the goal image has been displayed to the image display. On the other hand, when it is determined to offer the special award, the photo-finish image is displayed to the image display after the goal image has been displayed to the image display; and thereafter, the image showing the order of finish of the race objects is displayed to the image display. Therefore, when it is determined to offer the special award, the image showing the order of finish of the race objects is not displayed immediately after the goal image has been displayed, but the photo-finish image is first displayed after the goal image has been displayed, and thereafter the image showing the order of finish of the race objects is displayed. It is therefore possible to make the player have an expectation as to which race object finished first.

Further, the present invention provides the following.

(8) The game control method according to the above-mentioned (5),

wherein

the step (G) includes the step of

(G-5) displaying to the image display an image showing that the special award will be offered.

According to the invention of (8), when it is determined to offer the special award, an image showing that the special award will be offered is displayed to the image display, which allows clear indication of offering of the special award. It is therefore possible to make the player easily recognize that the special award will be offered.

According to the present invention, it is possible to provide a gaming apparatus and a game control method with such consideration as to prevent a player from getting bored and also to enhance liveliness.

### BRIEF DESCRIPTIONS OF THE DRAWINGS

FIG. 1A is a view showing an example of images displayed to a main monitor of a horse racing game apparatus according to the present embodiment; FIG. 1B is another view showing an example of images displayed to the main monitor of the horse racing game apparatus according to the present embodiment.

FIG. 2 is a perspective view schematically showing an example of the horse racing game apparatus according to the present embodiment.

FIG. 3 is a perspective view schematically showing an example of the stations shown in FIG. 2.

FIG. 4 is a block diagram showing an internal configuration of a main game portion provided in the horse racing game apparatus shown in FIG. 2.

FIG. 5 is a block diagram showing an internal configuration of a station provided in the horse racing game apparatus shown in FIG. 2.

FIG. 6 is a flowchart showing an example of game operations in the horse racing game apparatus in the present embodiment.

FIG. 7 is a view schematically showing an example of bet images displayed to a sub monitor.

FIG. 8 is a flowchart showing a subroutine of a racing game execution processing performed in the main game portion.

### DESCRIPTION OF THE EMBODIMENTS

An embodiment of the present invention is described based on the drawings. In the following, the case of applying the present invention to a horse racing game apparatus is described as a preferred embodiment of the present invention. It is to be noted that a game in the present invention is a game totally processed by a CPU, except for input performed by a player.

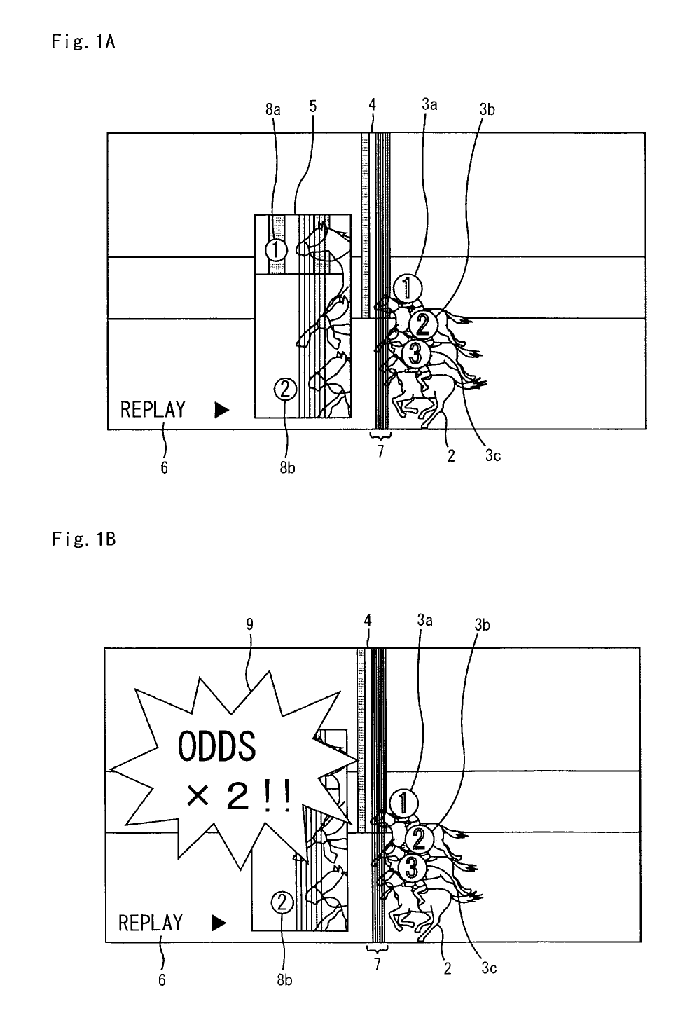

FIGS. 1A and 1B are views showing a characteristic of a horse racing game apparatus of the present embodiment, and also views showing an example of images displayed to a main monitor of the horse racing game apparatus according to the present embodiment.

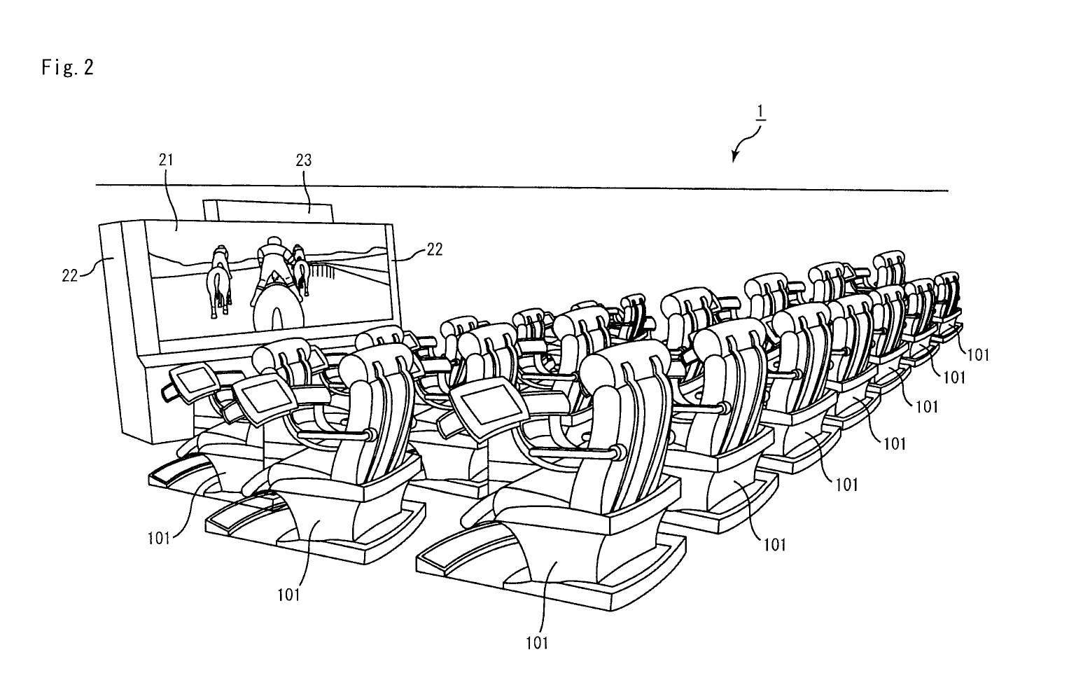

FIG. 2 is a perspective view schematically showing an example of a horse racing game apparatus according to the present embodiment.

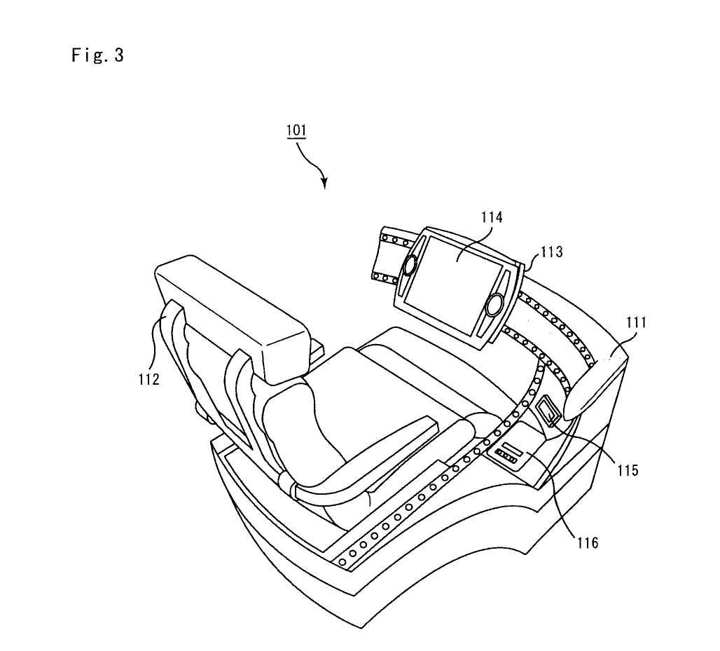

FIG. 3 is a perspective view schematically showing an example of the stations shown in FIG. 2.

As shown in FIG. 2, a horse racing game apparatus 1 according to the present embodiment includes a main monitor 21, and a plurality of stations 101 installed so as to face the main monitor 21.

The stations 101 each has a sub monitor 113 installed on a cabinet 111 so as to face a chair 112; and a touch panel 114 is provided on the front face of the sub monitor 113.

The player seated at each station 101 predicts a result of a racing game (hereinafter, also referred to as a “race”) and inputs a bet by the use of the touch panel 114 provided on each station 101, to participate in a horse racing game. After the end of a bet-input acceptance period, an image of a plurality of racehorses running in a race is displayed to the main monitor 21. When the prediction of the player proves correct, game media in number based on the number of bets and odds are paid out (hereinafter also referred to as a “normal payout”).

Further, in the horse racing game apparatus 1, it is determined whether or not to offer a special award different from the normal award; and when it is determined to offer the special award, a photo-finish image 5, formed by enlarging a portion of a goal image showing the state of a race object first crossing the finish line is displayed to the main monitor 21, the portion including the nose tip of each of the racehorses finishing first and second.

The main monitor 21 corresponds to the image display in the present invention.

FIG. 1A is a view showing an example of images displayed to the main monitor of the horse racing game apparatus according to the present embodiment.

As shown in FIG. 1A, to the main monitor 21, a racehorse image 2 is displayed which shows the state of a plurality of racehorses running from the right side to the left side of the main monitor 21.

Further, horse number images 3 (horse number images 3a, 3b and 3c) showing numbers of respective racehorses (hereinafter also referred to as “horse numbers”) are displayed around the racehorse image 2. The horse number image 3a shows a horse number 1, the horse number image 3b shows a horse number 2, and the horse number image 3c shows a horse number 3. Moreover, a goal board image 4 showing a goal point is displayed in the back of the racehorse image 2. Six straight line images 7 (straight line images 7a, 7b, 7c, 7d, 7e, and 7f in order from the center of the goal board image 4) are provided in parallel at given intervals in a direction from the center of the goal board image 4 toward the right side thereof. The straight line images 7 are images provided so as to make it easier for the player to visually recognize which race object has finished first.

Further, at the substantial center of the main monitor 21, a photo-finish image 5 formed by enlarging a portion of the racehorse image 2, the portion including the nose tip of each of the first and second racehorses, is displayed.

Moreover, at the front of the photo-finish image 5, order-of-finish images 8 (an order-of-finish image 8a, an order-of-finish image 8b) are displayed which show the order of the race objects. The order-of-finish image 8a shows that the order of finish is first, and the order-of-finish image 8b shows that the order of finish is second. Namely, the image shown in FIG. 1A shows that the racehorse of horse number 1 has finished first and the racehorse of horse number 3 has finished second. The order-of-finish images 8 correspond to the images showing the order of finish of race objects in the present invention.

Further, to the left of the photo-finish image 5, a replay display image 6 is displayed which shows that an image currently displayed is a replay image.

FIG. 1B is a view showing an example of images displayed to the main monitor of the horse racing game apparatus according to the present embodiment. FIG. 1B is an image displayed after the image of FIG. 1A has been displayed to the main monitor 21.

On the left side of the central portion of FIG. 1B, an odds-doubling image 9 is displayed which shows the player that the odds will be doubled. The odds-doubling image 9 corresponds to the image showing that the special award will be offered, in the present invention.

Further, the racehorses correspond to the race objects in the present invention.

FIG. 2 is a perspective view schematically showing an example of horse racing game apparatuses according to the present embodiment.

The horse racing game apparatus 1 includes: the main monitor 21; speakers 22 installed on both the right and left sides of the main monitor 21; an indicator 23 installed on a top of the main monitor 21; and the plurality of stations 101 installed so as to face the main monitor 21.

To the main monitor 21, an image showing the progress of a race, and the like, are displayed. From the speakers 22, a sound in accordance with the progress of the race is outputted. To the indicator 23, information regarding the game in general and the like are displayed.

It is to be noted that the station 101 corresponds to the bet input device in the present invention.

FIG. 3 is a perspective view schematically showing an example of the stations shown in FIG. 2.

The station 101 has: the cabinet 111, the chair 112 installed inside the cabinet 111; the sub monitor 113 installed on the cabinet 111 so as to face the chair 112; the touch panel 114 installed on the screen of the sub monitor 113; a bill validator 115 installed on the cabinet 111 to the right of the chair 112; and a ticket printer 116 installed below the bill validator 115.

To the sub monitor 113, a later-described bet image, an effect image in accordance with the progress of a racing game, and the like, are displayed. The touch panel 114 is used when the player performs input, such as a bet operation that uses the bet image.

The bill validator 115 identifies validity of a bill, and accepts a regular bill into the cabinet 111. The bill accepted into the cabinet 111 is converted into the number of coins at a prescribed rate, and the number of credits corresponding to the number of coins is added to the number of credits owned by the player. It is to be noted that the bill validator 115 may be configured so as to be capable of reading a later-described ticket 39 with a barcode.

The ticket printer 116 prints on a ticket a barcode formed by encoding data such as the number of credits, date and time, and an identification number of the station 101, and outputs the ticket as the ticket 39 with a barcode. The player can make another station read the ticket 39 with a barcode and play a game on that station 101, or exchange the ticket 39 with a barcode with bills or the like at a prescribed place in a gaming facility (e.g. cashier booth in a casino).

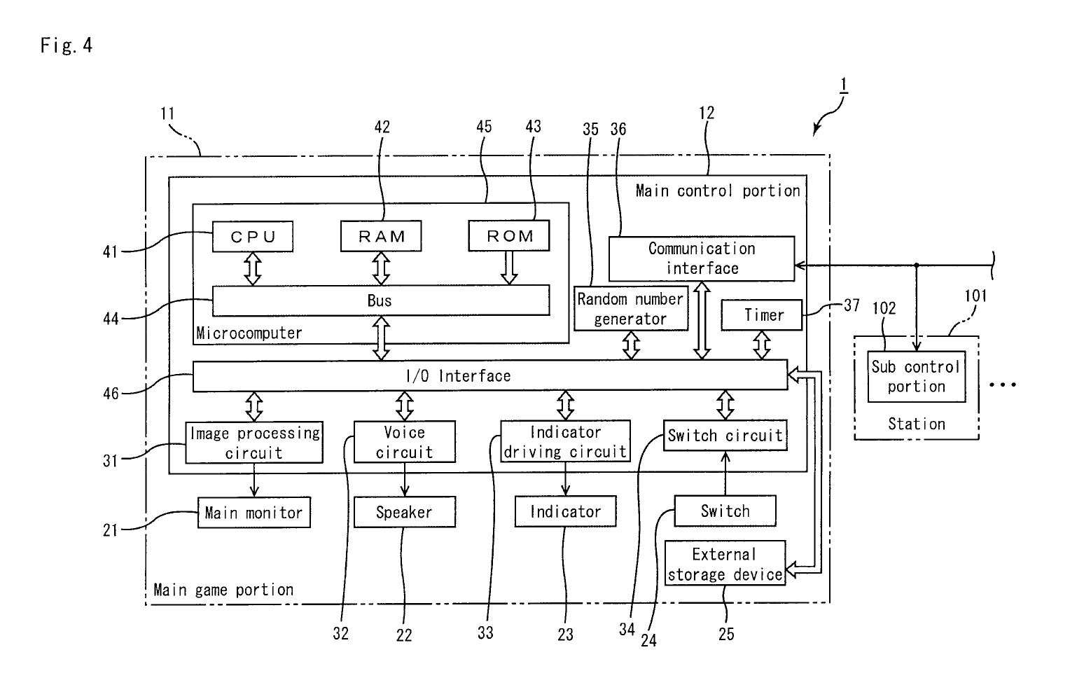

FIG. 4 is a block diagram showing an internal configuration of a main game portion provided in the horse racing game apparatus shown in FIG. 2.

A main game portion 11 is a central portion of the horse racing game apparatus 1 in the present embodiment. The main game portion 11 has a main control portion 12, the main monitor 21, the speakers 22, the indicator 23, a switch 24, and an external storage device 25.

The main control portion 12 has a microcomputer 45, arranged on a circuit board, as a main constituent. The microcomputer 45 has a CPU 41 that performs a control operation in accordance with a previously set program, a RAM 42, and a ROM 43.

The RAM 42 is a memory for temporarily storing a variety of data computed in the CPU 41. The ROM 43 stores a variety of programs for performing processing necessary in controlling the horse racing game apparatus 1, and the like. Further, the ROM 43 stores information regarding a plurality of racehorses, data on winning percentage of the respective racehorses, and the like, in association with the racehorse IDs.

The microcomputer 45 is connected with an image processing circuit 31 through an I/O interface 46. The image processing circuit 31 is connected to the main monitor 21, and controls the drive of the main monitor 21.

The image processing circuit 31 has a program ROM 311, an image ROM 312, an image control CPU 313, a work RAM 314, an image data processor 315 (hereinafter also referred to as a “VDP 315”), and a video RAM 316.

The program ROM 311 stores a program for image control regarding display within the main monitor 21, and a variety of selection tables.

Further, the image ROM 312 stores, for example, dot data for forming an image within the main monitor 21 and a variety of image data such as background image data, image data of racehorses, odds-doubling image data, and order-of-finish image data.

Further, the image control CPU 313 determines an image to be displayed to the main monitor 21 out of the dot data and image data previously stored inside the image ROM in accordance with the image control program previously stored inside the program ROM, based on a parameter set in the microcomputer 45.

Further, the work RAM 314 is configured as a temporary storage unit in execution of the image control program in the image control CPU 313.

Furthermore, the VDP 315 generates image data in accordance with display contents determined in the image control CPU 313, and outputs the data to the main monitor 21.

Moreover, the video RAM 316 is configured as a temporary storage unit in formation of an image in the VDP 315.

The microcomputer 45 is connected with a voice circuit 32 through the I/O interface 46. The voice circuit 32 is connected with the speakers 22. The speakers 22 are provided on the right and left sides of the main monitor 21, and output a sound under output-control by the voice circuit 32, based on a drive signal from the CPU 41.

The microcomputer 45 is connected with an indicator driving circuit 33 through the I/O interface 46. The indicator driving circuit 33 is connected with the indicator 23. The indicator 23 is provided on the top of the main monitor 21, and displays information regarding a game in general, and the like, under display-control by the indicator driving circuit 33, based on a drive signal from the CPU 41.

The microcomputer 45 is connected with a switch circuit 34 through the I/O interface 46. The switch circuit 34 is connected with the switch 24. The switch 24 is provided below the main monitor 21, and inputs a command by a setting operation performed by an operator into the CPU 41, based on a switch signal from the switch circuit 34.

The microcomputer 45 is connected with a random number generator 35 through the I/O interface 46. The random number generator 35 generates a random number to be sampled by the CPU 41.

The microcomputer 45 is connected with a timer 37 through the I/O interface 46. The timer 37 is used for measuring time at the start of a racing game, and the like.

The microcomputer 45 is connected with the external storage device 25 through the I/O interface 46. The external storage device 25 is provided on the periphery of the main monitor 21. Further, for example, storing the dot data for forming an image and the like into the external storage device 25 allows the external storage device 25 to have a function similar to that of the image ROM 312 inside the image processing circuit 31. Therefore, when determining an image to be displayed to the main monitor 21, the image control CPU 313 inside the image processing circuit 31 also takes the dot data and the like previously stored inside the external storage device 25 as objects for the determination.

The microcomputer 45 is connected with the communication interface 36 through the I/O interface 46. The communication interface 36 is connected with a sub control portion 102 of each of the stations 101. Therefore, the CPU 41 transmits and receives a command, a request, data, and the like, to and from each of the stations 101 through the communication interface 36.

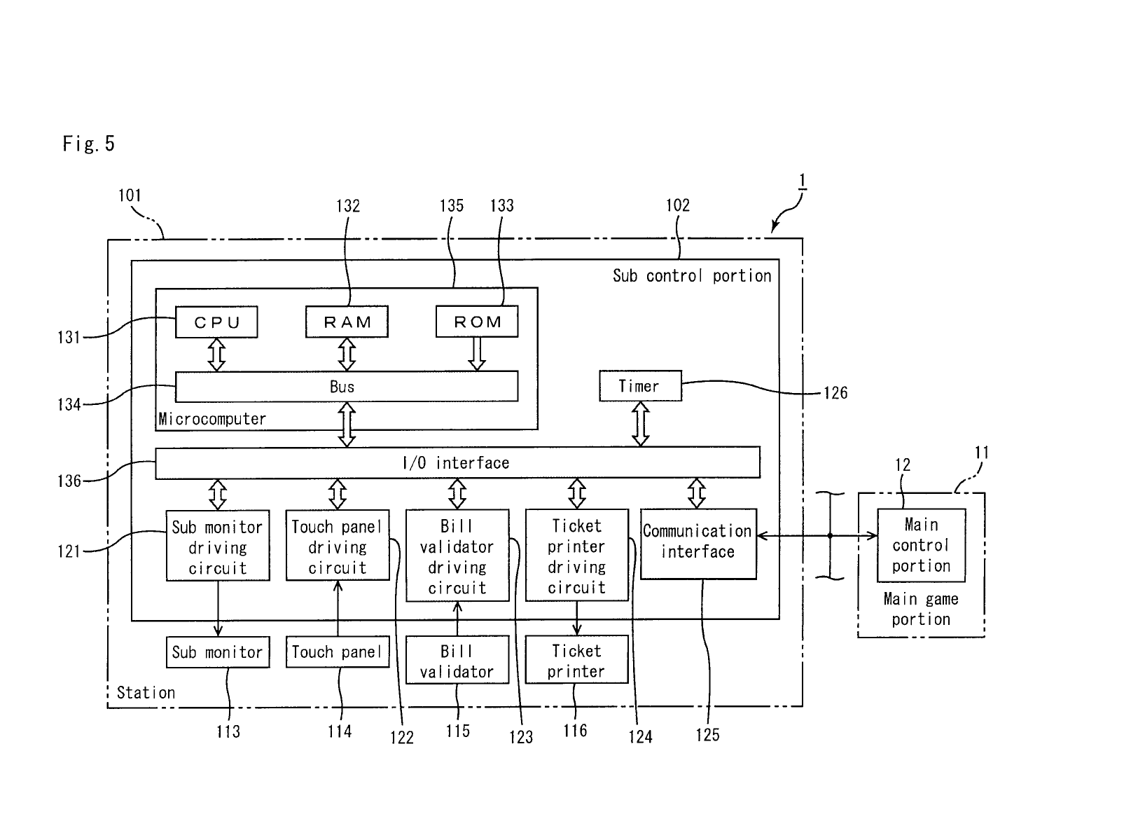

FIG. 5 is a block diagram showing an internal configuration of the station provided in the horse racing game apparatus shown in FIG. 2.

The station 101 includes the sub control portion 102, the sub monitor 113, the touch panel 114, the bill validator 115, and the ticket printer 116.

The sub control portion 102 has the microcomputer 135 arranged on the circuit board, as a main constituent. The microcomputer 135 has a CPU 131 that performs a control operation in accordance with a previously set program, a RAM 132, and a ROM 133.

The RAM 132 is a memory for temporarily storing a variety of data computed in the CPU 131. The ROM 133 stores a variety of programs for performing processing necessary in controlling the horse racing game apparatus 1, a data table, and the like.

The microcomputer 135 is connected with a sub monitor driving circuit 121 through an I/O interface 136. The sub monitor driving circuit 121 is connected with the sub monitor 113. The sub monitor driving circuit 121 controls the drive of the sub monitor 113, based on a drive signal from the main game portion 11. The sub monitor driving circuit 121 has a configuration and function similar to those of the image processing circuit 31, and for example, controls the drive of the sub monitor 113 so that a later-described bet image is displayed.

The microcomputer 135 is connected with a touch panel driving circuit 122 through the I/O interface 136. The touch panel driving circuit 122 is connected with the touch panel 114. The touch panel 114 is provided on the screen of the sub monitor 113, and inputs into the CPU 131a command by a touching operation of the player as a coordinate signal from the touch panel driving circuit 122.

The microcomputer 135 is connected with a bill validator driving circuit 123 through the I/O interface 136. The bill validator driving circuit 123 is connected with the bill validator 115. The bill validator 115 identifies validity of a bill and the ticket 39 with a barcode. When accepting a regular bill, the bill validator 115 inputs the amount of the accepted bill into the CPU 131, based on an identification signal from the bill validator driving circuit 123. Further, when accepting a regular ticket 39 with a barcode, the bill validator 115 inputs into the CPU 131 the number of credits and the like which are recorded on the ticket 39 with a barcode, based on an identification signal from the bill validator driving circuit 123.

The microcomputer 135 is connected with a ticket printer driving circuit 124 through the I/O interface 136. The ticket printer driving circuit 124 is connected with the ticket printer 116. The ticket printer 116 prints on a ticket a barcode formed by encoding data such as the number of owned credits stored in the RAM 132, and the like, and outputs the ticket as the ticket 39 with a barcode under output-control by the ticket printer driving circuit 124, based on a drive signal outputted from the CPU 131.

The microcomputer 135 is connected with a communication interface 125 through the I/O interface 136. The communication interface 125 is connected with the main control portion 12 of the main game portion 11. Therefore, the CPU 131 transmits and receives a command, a request, data, and the like, to and from the main game portion 11 through the communication interface 125.

The microcomputer 135 is connected with the timer 126 through the I/O interface 136. The timer 126 is used for measuring time in ending acceptance of the bet operation.

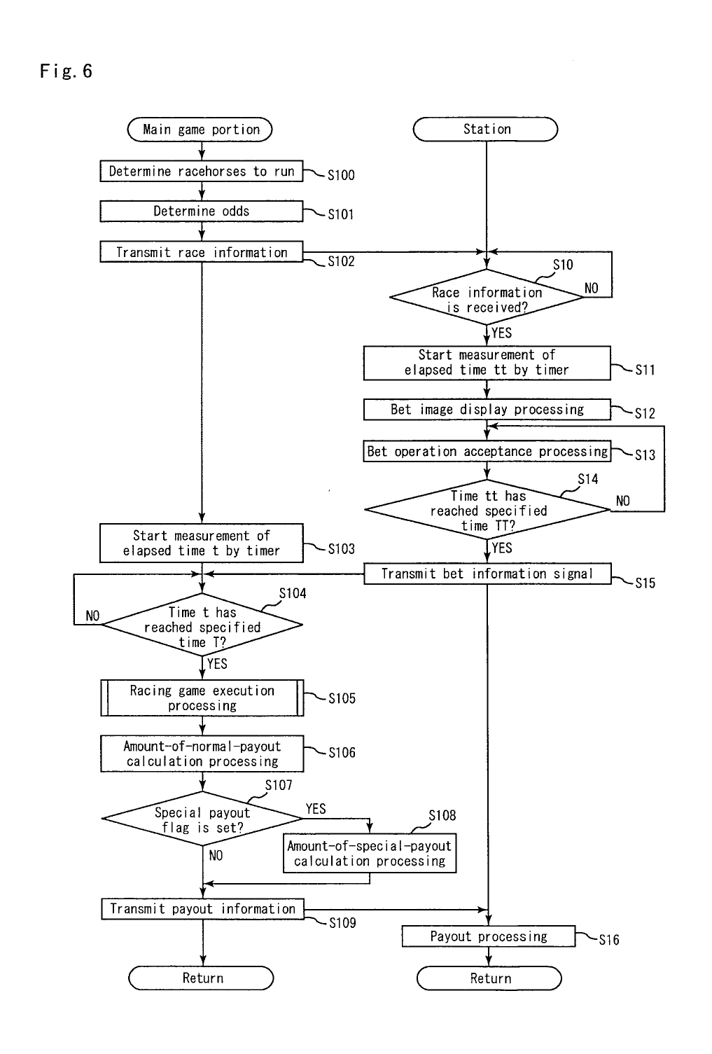

FIG. 6 is a flowchart showing an example of game operations in the horse racing game apparatus in the present embodiment.

It is to be noted that FIG. 6 shows only processing performed in one station 101 for the sake of avoiding complexity.

In the main game portion 11, respective operations of steps S100 to S109 are performed.

First, in step S100, the CPU 41 selects information regarding a prescribed number of (e.g. 6) racehorses out of information regarding a plurality of racehorses stored in the ROM 43, based on random numbers generated by the random number generator 35, and determines those horses as racehorses to run in a race this time around. At this time, the CPU 41 provides starting numbers of “1” to “6” to the racehorses to run.

Next, in step S101, the CPU 41 executes processing of determining odds per betting ticket system. At this time, the CPU 41 sets odds, based on winning percentage data of each racehorse which is stored in the ROM 43. Therefore, order-of-finish prediction odds including a racehorse with a high winning probability are set low, whereas order-of-finish prediction odds including a racehorse with a low winning probability are set high.

In step S102, the CPU 41 transmits, to each station 101, race information on the racehorses to run and odds which have been determined in the processing of step S100 and step S101.

Next, in step S103, the CPU 41 starts measuring elapsed time t by the timer 37.

Next, in step S104, the CPU 41 determines whether or not the elapsed time t measured by the timer 37 has reached previously-set specified time T (e.g. 60 seconds). When determining that the elapsed time t has not reached the specified time T, the CPU 41 returns the processing to step S104. On the other hand, when determining that the elapsed time t has reached the specified time T, the CPU 41 shifts the processing to step S105.

In step S105, the CPU 41 executes racing game execution processing.

In this racing game execution processing, the CPU 41 determines an order of finish of each racehorse in the racing game, based on a random number generated by the random number generator 35. Further, the CPU 41 determines whether or not to offer a special payout, based on a random number generated by the random number generator 35. When determining to offer the special payout, the CPU 41 sets a special payout flag. The CPU 41 then controls the VDP 315, to output an image showing the race progress to the main monitor 21, based on the determined order of finish of each racehorse.

This racing game execution processing is detailed later using a drawing.

In step S106, the CPU 41 calculates an amount of normal payout for each station 101, based on the order of finish of each racehorse which has been determined in the racing game execution processing of step S105 and on a bet information signal transmitted from each station 101 in later-described processing of step S15.

Subsequently, in step S107, the CPU 41 determines whether or not a special payout flag is set. When determining that the special payout flag is not set, the CPU 41 shifts the processing to step S109. On the other hand, when determining that the special payout flag is set, the CPU 41 shifts the processing to step S108.

In step S108, the CPU 41 regards an amount of payout equal to the amount of normal payout calculated in step S106, as an amount of special payout. Namely, the special payout in the same amount as the amount of the normal payout will be offered, meaning that the odds will be doubled.

Next, in step S109, the CPU 41 transmits each of the amounts of payout calculated in the processing of step S106 and step S108 as payout information to each corresponding station 101.

Hereafter, the same processing is repeated in subsequent races.

Meanwhile, in each of the stations 101, respective operations of steps S10 to S16 are performed.

First, in step S10, the CPU 131 determines whether or not race information has been received from the main game portion 11. When determining that the information has not been received, the CPU 131 returns the processing to step S10. On the other hand, when determining that the information has been received, the CPU 131 shifts the processing to step S11.

In step S11, the CPU 131 starts measuring elapsed time tt by the timer 126.

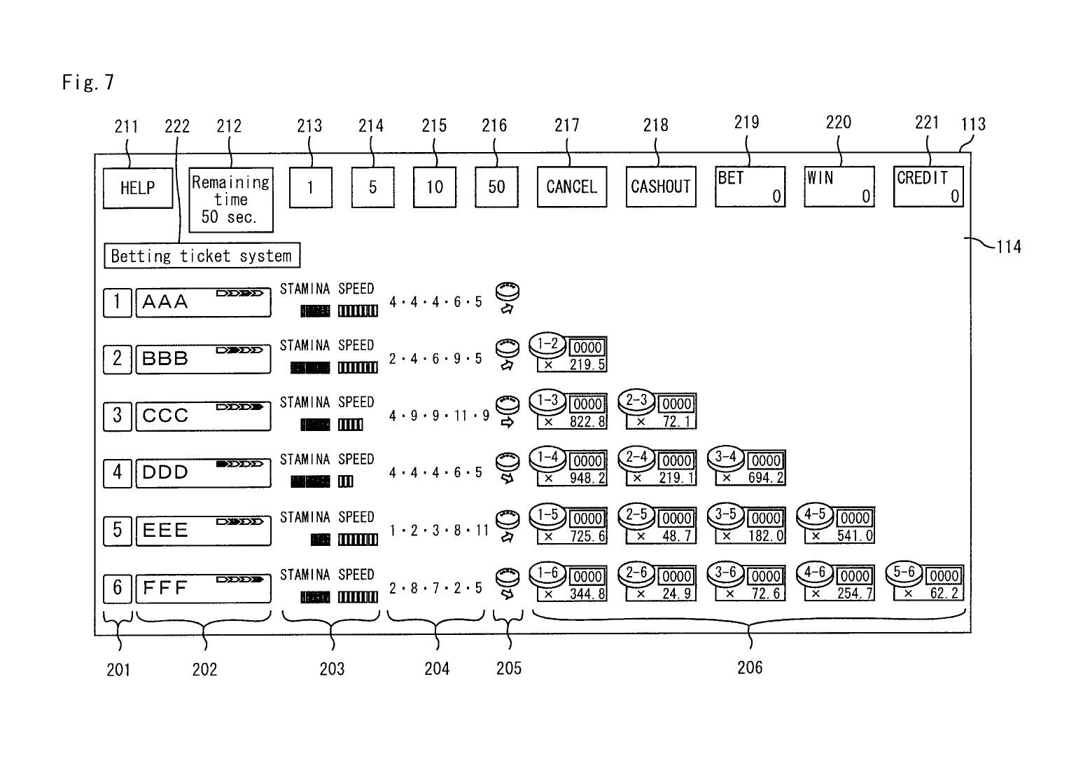

In step S12, the CPU 131 displays a bet image to the sub monitor 113, based on the race information transmitted from the CPU 41. FIG. 7 shows an example of bet images displayed to the sub monitor 113.

FIG. 7 is a view schematically showing an example of bet images displayed to the sub monitor. The bet image displayed to the screen of the sub monitor 113 covered by the touch panel 114 is provided with: a horse number display region 201; a horse name display region 202; a basic ability display region 203 displaying speed and stamina by means of bar charts; a record display region 204 displaying orders of finish in last five races; a condition display region 205 displaying current conditions by means of arrows; and a betting ticket purchase button display region 206 displaying, with odds and number of bets, a betting ticket perchance button for quinella in which a combination of horse numbers that will finish first and second in any order is predicted.

Further, the bet image includes images of a help button 211, a 1-bet button 213, a 5-bet button 214, a 10-bet button 215, a 50-bet button 216, a cancel button 217, a cash-out button 218, and a betting ticket system switch button 222.

Moreover, the bet image is provided with a time display region 212, a number-of-bets display region 219, an amount-of-payout display region 220, and a number-of-credits display region 221.

The help button 211 is a button to be touched by the player for displaying an operation method for betting and the like to the sub monitor 113. In the time display region 212, remaining time possible for bet-input is displayed. The 1-bet button 213 is a button to be touched by the player for adding “1” to the current number of bets. The 5-bet button 214 is a button to be touched by the player for adding “5” to the current number of bets. The 10-bet button 215 is a button to be touched by the player for adding “10” to the current number of bets. The 50-bet button 216 is a button to be touched by the player for adding “50” to the current number of bets.

The cancel button 217 is a button to be touched by the player for cancelling the added number of bets. The cash-out button 218 is a button to be touched by the player for paying out coins in number in accordance with the number of credits owned by the player by means of the ticket 39 with a barcode. In the number-of-bets display region 219, the total number of bets set by the player in the current race is displayed. The amount-of-payout display region 220 displays an amount of payout in the race this time around. In the number-of-credits display region 221, the number of credits owned by the player is displayed.

Although the bet image shown in FIG. 7 is the quinella bet image, every time a betting ticket system switch button 222 is touched, the bet image is switched to win, place, exacta, trifecta, bracket quinella, trio, quinella-place (wide), and the like.

The player touches any of the 1-bet button 213, the 5-bet button 214, the 10-bet button 215, and the 50-bet button 216, and then touches any betting ticket purchase button within the betting ticket purchase button display region 206, so as to place a bet. For example, when touching the 10-bet button 215 and then touching a “1-2” betting ticket purchase button within the betting ticket purchase button display region 206, the player can add “10” to the current number of bets on “1-2”. Here, “1-2” means that a combination of No. 1 horse and No. 2 horse will take first and second place in any order. It is to be noted that the current number of bets on each combination of horse numbers is displayed next to the betting ticket purchase button corresponding to each combination.

Returning to FIG. 6, in step S13, the CPU 131 specifies contents of the bet operation performed by the player based on a coordinate signal from the touch panel driving circuit 122, and stores the contents into the RAM 132. Further, The CPU 131 reflects the contents of the bet operation to the display on the bet image of the sub monitor 113.

In step S14, the CPU 131 determines whether or not the elapsed time tt measured by the timer 126 has reached specified time TT (e.g. 60 seconds). When determining that the elapsed time tt has not reached the specified time TT, the CPU 131 returns the processing to step S13. On the other hand, when determining that the elapsed time tt has reached the specified time TT, the CPU 131 shifts the processing to step S15.

In step S15, the CPU 131 transmits bet information showing the contents of the bet operation as a bet information signal to the main control portion 12 through the communication interface 125. It is to be noted that the bet information signal includes at least an ID of a racehorse on which the bet has been placed, the number of bet game media, information regarding the type of a betting ticket, and an identification number of the station 101.

In step S16, based on payout information transmitted from the main game portion 11, the CPU 131 updates the number of credits owned by the player which is stored in the RAM 132, and also updates display in the amount-of-payout display region 220 and the number-of-credits display region 221 on the bet image of the sub monitor 113.

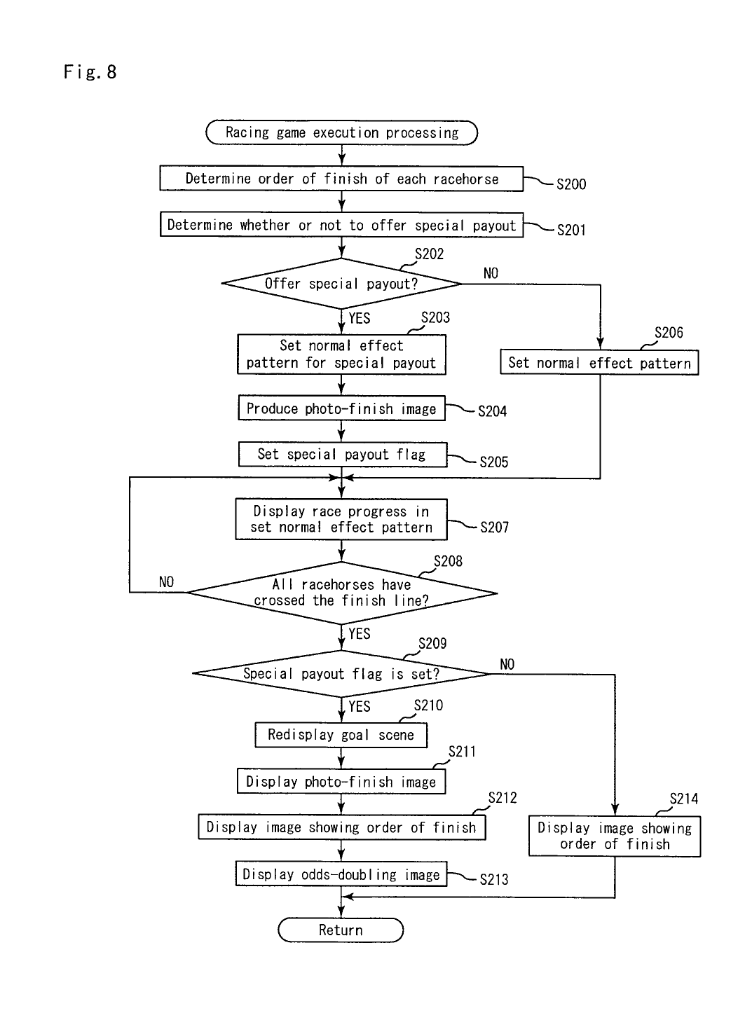

FIG. 8 is a flowchart showing a subroutine of racing game execution processing performed in the main game portion.

First, in step S200, the CPU 41 determines an order of finish of each racehorse in the racing game, based on random numbers generated by the random number generator 35.

Next, in step S201, the CPU 41 determines whether or not to offer a special payout, based on a random number generated by the random number generator 35.

Next, in step S202, the CPU 41 determines whether or not it has been determined to offer the special payout; when it has been determined to offer the special payout, the CPU 41 shifts the processing to step S203.

In step S203, the CPU 41 sets a normal effect pattern for special payout, based on the order of finish of each racehorse determined in the processing of step S200. This normal effect pattern for special payout is set such that a plurality of racehorses cross the finish line almost simultaneously. Here, “almost simultaneously” means, for example, by a difference of a nose, a difference of a head, a difference of a neck, a difference of half a horse body, or the like. Under control of the CPU 41, the VDP 315 produces an effect image of each racehorse from the start to finish (image showing a race progress), based on background image data, image data of the racehorses, and the like, which are stored in the image ROM 312. Further, under control of the CPU 41, the VDP 315 produces a goal effect image as an effect image of each racehorse from a point immediately before the finish line (e.g. a 50-meter remaining point before the finish line) to the finish line, based on the background image data, the image data of the racehorses, and the like, which are stored in the image ROM 312.

Next, in step S204, under control of the CPU 41, the VDP 315 produces the photo-finish image 5, which is an image formed by enlarging a portion including the racehorse finishing first therein of the goal image showing the state of the racehorse first crossing the finish line, the goal image included in the effect images produced in step S203. The CPU 41 then sets a special payout flag (step S205).

On the other hand, when it has been determined in step S202 not to offer the special payout, the CPU 41 sets a normal effect pattern, based on the order of finish of each racehorse determined in the processing of step S200 (step S206). Under control of the CPU 41, the VDP 315 produces an effect image of each racehorse from the start to the finish based on the background image data, the image data of the racehorses, and the like which are stored in the image ROM 312.

In step S207, the CPU 41 controls the VDP 315 so as to display the effect image produced in the processing of step S203 or step S206, to the main monitor 21.

Next, in step S208, the CPU 41 determines whether or not all the racehorses running in the racing game have crossed the finish line. When determining that all the racehorses have not crossed the finish line, the CPU 41 shifts the processing to step S207. On the other hand, when determining that all the racehorses have crossed the finish line, the CPU 41 shifts the processing to step S209.

In step S209, the CPU 41 determines whether or not the special payout flag is set. When determining that the special payout flag is set, the CPU 41 shifts the processing to step S210.

In step S210, the CPU 41 controls the VDP 315 so as to display the goal effect image produced in the processing of step S203, to the main monitor 21.

In step S211, the CPU 41 controls the VDP 315 so as to display the photo-finish image 5 produced in the processing of step S204, to the main monitor 21.

Next, in step S212, the CPU 41 reads the order-of-finish image data stored in the image ROM 312, and controls the VDP 315 so as to display the order-of-finish images 8 to the main monitor 21.

Subsequently, in step S213, the CPU 41 reads the odds-doubling image data stored in the image ROM 312, and controls the VDP 315 so as to display the odds-doubling image 9 to the main monitor 21.

On the other hand, when determining that the special payout flag is not set, the CPU 41 reads the order-of-finish image data stored in the image ROM 312, and controls the VDP 315 so as to display the order-of-finish images 8 to the main monitor 21 (step S214).

After the processing of step S213 or step S214, the present subroutine is completed.

As described above, according to the horse racing game apparatus 1 and the game control method relating to the present embodiment, a normal payout is offered based on a bet accepted from the bet input device and the order of finish of racehorse. Further, it is determined whether or not to offer a special payout different from the normal payout. When it is determined not to offer the special payout, an image showing the order of finish of the racehorses is displayed to the image display after a goal image showing the state of a racehorse first crossing the finish line has been displayed to the image display. On the other hand, when it is determined to offer the special payout, a photo-finish image, which is an image formed by enlarging a portion of the goal image, the portion at least including the racehorse finishing first, is displayed to the image display after the goal image has been displayed to the image display; and thereafter the image showing the order of finish of the racehorses is displayed to the image display.

Therefore, according to the horse racing game apparatus 1 relating to the present embodiment, since a game does not monotonously proceed but a varied game proceeds due to a special effect of displaying the photo-finish image, it is possible to prevent the player from getting bored and also to enhance liveliness. Further, when it is determined to offer the special payout, the image showing the order of finish of the racehorses is not displayed immediately after the goal image has been displayed, but the photo-finish image is first displayed after the goal image has been displayed, and then the image showing the order of finish of the racehorses is displayed. It is therefore possible to make the player have an expectation as to which racehorse has finished first.

In the present embodiment, the case has been described where racehorses to run are determined based on random numbers generated by the random number generator 35. However, in the present invention, racehorses may be made to run in sequential order. For example, racehorses may be made to run in a racing game in order of racehorse ID. Further, racehorses may be divided into groups each consisting of a prescribed number of (e.g. 6) racehorses, and made to run in the unit of groups in order of group.

In the present embodiment, the case has been described where the effect images of the respective racehorses from the start to finish (images showing race progress), the goal effect image, the photo-finish image 5, the order-of-finish images 8, and the odds-doubling image 9 are displayed to the main monitor 21. However, in the present invention, effect images and images formed by enlarging at least a portion of the effect images may be displayed to a sub monitor.

In the present embodiment, the case has been described where one racecourse is stored in the ROM 43. However, in the present invention, a plurality of racecourses may be stored in the ROM; for example, a dirt course, a turf course, a clockwise course, a counter-clockwise course, courses having different race distances, and the like may be stored in the ROM.

Specifically, the CPU 41 selects one racecourse out of a plurality of racecourses stored in the ROM 43 based on a random number generated by the random number generator 35, and takes the selected racecourse as a course of the race this time around. Further, the CPU 41 transmits to each station 101 the selected racecourse as race information, along with racehorses to run and odds thereof which have been determined in the processing of step S100 and step S101.

In the present embodiment, the case has been described where it is determined whether or not to offer the special payout, based on a random number generated by the random number generator 35. However, in the present invention, the special payout may be offered when a prescribed condition is satisfied. The prescribed condition may, for example, be that the cumulative total number of betted game media exceeds a previously set prescribed number in the horse racing game apparatus 1, that the total number of betted game media in the current racing game exceeds the prescribed number, that the game media in the prescribed number or more have been paid out in the previous racing game, or that the prescribed time has come.

In the present embodiment, the case has been described where the amount of payout equal to the amount of normal payout calculated in step S106 is regarded as the amount of special payout. However, in the present invention, game media in previously set number (e.g. 1000) may be the special payout. Namely, such a configuration offers game media in the prescribed number, as the special payout, regardless of the number of betted game media. Therefore, this configuration makes it possible to reduce a loss of a gaming facility side in the case of offering the special payout to a player who has betted a large amount of game media, and to make a player, having betted only a small amount of game media, have a feeling of satisfaction in the case of offering the special payout to such a player.

In the present embodiment, the case has been described where one photo-finish image 5 is displayed to the main monitor 21. However, in the present invention, a plurality of images formed by enlarging at least portions of a plurality of effect images may be displayed to the image display at prescribed time intervals.

Specifically, under control of the CPU 41, the VDP 315 produces a plurality of photo-finish images 5 formed by enlarging portions including the racehorse finishing first therein of a plurality of images before and after the racehorse finishing first crosses the finish line, the plurality of images included in the effect images produced in step S203. Then, the CPU 41 controls the VDP 315 so as to display the produced plurality of photo-finish images 5 to the main monitor 21 at prescribed time intervals.

Such a configuration makes it possible to display a goal scene by a single frame step by displaying to the image display the plurality of images formed by enlarging the portions including at least a race object finishing first therein of the images before and after the race object finishing first crosses the finish line; it is therefore possible to have the player's attention riveted on the images, so as to make the player absorbed in the game.

In the present embodiment, the case has been described where photo-finish image 5 is displayed as a portion of an image displayed to the main monitor 21. However, in the present invention, an image formed by enlarging at least a portion of an effect image may be displayed to the whole image display. Further, as described above, in a case where a goal scene is displayed by a single frame step, the state of racehorses crossing the finish line, the image of the racehorses being larger than actual racehorses, is displayed by single frame step; therefore, it is possible to excite the player more than in the case of watching a real horse racing.

In the present embodiment, the case of applying the present invention to the horse racing game apparatus 1 has been described, but in the present invention, a bike racing game apparatus, a boat racing game apparatus, a dog racing game apparatus, a car racing game apparatus, a motorcycle racing game apparatus, or the like may be adopted. In the case of forming such a configuration, bikes, motorboats, dogs, cars, or motorcycles correspond to the race objects in the present invention.

Although the embodiment of the present invention has been described above, it just presents a specific example, and does not particularly limit the present invention. A specific configuration of each unit or the like can be appropriately changed in terms of design. Further, the description of the effects made in the embodiment of the present invention are only recitation of the most preferable effects that arise from the present invention, and the effects according to the present invention are not limited to those described in the embodiment of the present invention.

What is claimed as new and desired to be secured by Letters Patent of the United States is:

1. A gaming apparatus, comprising:
an image display capable of displaying an image;
a bet input device with which a bet on a race object that participates in a racing game in which a plurality of race objects contend with one another for winning can be inputted; and
a controller,
said controller programmed so as to execute the processing of
(A) accepting a bet from said bet input device,
(B) proceeding with said racing game,
(C) displaying an effect image in accordance with the progress of said racing game,
(D) determining the order of finish of said plurality of race objects that participate in said racing game,
(E) offering a normal award, based on the bet accepted in said processing (A) and on the order of finish of said race object which has been determined in said processing (D),
(F) determining whether or not to offer a special award different from said normal award offered in said processing (E) and
(G) displaying to said image display an enlarged view of at least a portion of said effect image, when it is determined in said processing (F) to offer said special award.

2. The gaming apparatus according to claim 1,
wherein
said processing (G) includes the processing of
(G-1) displaying to said image display a photo-finish image formed by enlarging a portion of a goal image showing the state of at least a race object first crossing the finish line, the portion including at least the race object finishing first, after displaying the goal image to said image display in said processing (C).

3. The gaming apparatus according to claim 2,
wherein
when it is determined in said processing (F) to offer said special award, said controller executes in said processing (G) the processing of
(G-2) displaying said photo-finish image to said image display after displaying said goal image to said image display in said processing (C), and
(G-3) displaying an image showing the order of finish of said race objects which has been determined in said processing (D) to said image display after displaying said photo-finish image to said image display, and
when it is determined in said processing (F) not to offer said special award, said controller executes in said processing (G) the processing of
(G-4) displaying an image showing the order of finish of said race objects which has been determined in said processing (D) to said image display after displaying said goal image to said image display in said processing (C).

4. The gaming apparatus according to claim 1,
wherein
said processing (G) includes the processing of
(G-5) displaying to said image display an image showing that said special award will be offered.

5. A game control method, including the steps of:
(A) accepting a bet from a bet input device with which a bet on a race object that participates in a racing game in which a plurality of race objects contend with one another can be inputted;
(B) proceeding with said racing game;
(C) displaying an effect image in accordance with the progress of said racing game;
(D) determining the order of finish of said plurality of race objects that participate in said racing game;
(E) offering a normal award, based on the bet accepted in said step (A) and on the order of finish of said race object which has been determined in said step (D);
(F) determining whether or not to offer a special award different from said normal award offered in said step (E); and
(G) displaying an enlarged view of at least a portion of said effect image to an image display capable of displaying an image, when it is determined in said step (F) to offer said special award.

6. The game control method according to claim 5,
wherein
said step (G) includes the step of
(G-1) displaying to said image display a photo-finish image formed by enlarging a portion of a goal image showing the state of at least a race object first crossing the finish line, the portion including at least the race object finishing first, after displaying the goal image to said image display in said processing (C).

7. The game control method according to claim 6,
wherein
when it is determined in said step (F) to offer said special award, said step (G) includes the steps of:
(G-2) displaying said photo-finish image to said image display after displaying said goal image to said image display in said step (C); and
(G-3) displaying an image showing the order of finish of said race objects which has been determined in said step (D) to said image display after displaying said photo-finish image to said image display, and
when it is determined in said step (F) not to offer said special award, said step (G) includes the step of
(G-4) displaying an image showing the order of finish of said race objects which has been determined in said step (D) to said image display after displaying said goal image to said image display in said step (C).

8. The game control method according to claim 5,
wherein
said step (G) includes the step of
(G-5) displaying to said image display an image showing that said special award will be offered.
